(19) United States
(12) Patent Application Publication
(10) Pub. No.: US 2004/0247843 A1
(43) Pub. Date: Dec. 9, 2004

(54) Method of applying a protective film, optionally including advertising or other visible material, to the surface of a handrail for an escalator or moving walkway

(76) Inventors: John McLeod, Toronto (CA); Viqar Haider, Markham (CA); Ion-Viorel Tatu, Mississauga (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/752,316

(22) Filed: Jan. 7, 2004

Related U.S. Application Data
(63) Continuation-in-part of application No. 09/252,784, filed on Feb. 19, 1999, now Pat. No. 6,682,806.

(51) Int. Cl. B66B 23/24

(52) U.S. Cl. 428/203; 428/195.1; 428/336; 198/336

(57) ABSTRACT

A film and a method of applying the film to a handrail of an escalator or moving walkway are provided. The film can be a single or double layered film. Printed matter, e.g. advertising, can be applied to or between the films. An apparatus and related method for applying the film are also included and rely on the motion of the handrail to unroll a supply of the film, with one or more rollers pressing the film onto the handrail. The film is stretched during application to prestretch and reduce tendency for compressive strains in use to cause wrinkling of the film and detachment from the handrail.

### CROSS REFERENCE TO RELATED APPLICATION

This application is a continuation-in-part of earlier application Ser. No. 09/252,784.

### FIELD OF THE INVENTION

This invention relates to handrails for escalators and moving walkways, and more particularly is concerned with applying a protective film, optionally including advertising or other visible material, to the surface of such a handrail.

### BACKGROUND OF THE INVENTION

Advertisers continually seek out new locations to place advertisements. It has been recognized for sometime that various forms of mass transit and the like offer good opportunities for advertising. Necessarily, mass transit systems offer a large potential audience, and a relatively small number of well positioned advertisements can be seen by a large number of people. Traveling on mass transit is usually fairly time-consuming and hence travelers of such systems often have plenty of time to view and read advertisements, which also make such advertising attractive to businesses. This has been well recognized in the past, and advertisers have sought various locations for placing advertisements.

Escalators and moving walkways are a common component of many mass transit systems, and are also found in numerous other locations with a high level of pedestrian traffic, e.g. large office buildings, shopping malls, large stores and the like. While traveling on an escalator is relatively quick compared to, say, a subway journey, an escalator ride nonetheless presents a potential audience for advertisers. While a ride on an escalator is relatively short, it is certainly long enough for a rider to notice and read an advertisement. Moreover, it is not really practical for an escalator rider to do anything else while riding the escalator, such as read a book or newspaper.

Advertisers have long recognized this, and it is common on well-used escalators to find various advertising panels. Thus, conventional poster advertising is often found lining the walls of escalator shafts. Additionally, advertisers have sought to place smaller, poster-like advertisements on smaller panels on top of the strip separating balustrades of up and down escalators. Commonly, advertisements would be placed on both sides, so as to present advertisements to riders on both the up and down escalators.

Ingenious advertisers have sought other ways of advertising on escalators. Thus, it has occurred to others that advertising could be placed on escalator handrails. This is attractive, since an escalator handrail presents an otherwise unused surface. As for grasping any object, a rider on an escalator will instinctively first look at the handrail to locate it. This ensures that the handrail, more often than not, will be at least glanced at by each user or rider. This makes it attractive for simple advertising, e.g. well known company logos and other advertising devices.

Thus, published Japanese application 57-130883 discloses a proposal for providing individual decals or stickers intended to be placed at regular intervals on an escalator handrail. These stickers include some sort of adhesive and a first film, and print ink applied to the rear of the first film.

The disadvantage with this proposal is that it requires each of these stickers or decals to be placed individually and discretely on the handrail. This is difficult, time-consuming and care would be needed to ensure that they are accurately and uniformly aligned. Moreover, each individual sticker would present a number of edges which could be caught, tending to remove it. Thus, its forward and trailing edges would present edges which could be readily caught by elements of the handrail drive mechanism. It would be appreciated that accidental removal of an adhesive sticker by the drive mechanism, so that the sticker then becomes entangled in the drive mechanism, is highly undesirable. Additionally, these edges, together with side edges of the decal would be readily visible to users, and it is believed that many users or riders of an escalator would, either deliberately, or absentmindedly, tend to pick at these edges and lift them up. This would either tend to remove each sticker or render it more susceptible to accidental entanglement in the drive mechanism.

An alternative proposal is found in Canadian patent 1,304,035 (Andrew B. French). This proposes a relatively complex construction which would require wholesale redesign of the structure of an escalator handrail. It proposes a handrail provided with some sort of a slot or the like and a transparent cover. Advertising material is then placed between the transparent cover and the main body of the handrail. This would, in theory, overcome some of the disadvantages of the Japanese proposal. Unfortunately, this proposal totally fails to address the structural requirements of an escalator handrail. A handrail is subjected to considerable stresses and strains, and one cannot simply remove substantial sections of the handrail cross-section without addressing the structural considerations.

For example, a transparent cover could be subject to substantial tensile and/or compressive stresses, depending on the drive mechanism, and this issue is not addressed. Necessarily, this proposal requires complete replacement of each escalator handrail with one according to this invention, if advertising is to be applied.

### SUMMARY OF THE INVENTION

A further consideration is that in many situations it may be desirable simply to provide some form of protective cover to an escalator handrail, and this is not addressed by any of the prior art proposals outlined above. First, many escalator handrails, after a period of use can develop a dull, worn appearance. Additionally, they may accidentally have various marks or discolourations on the surface, due either to the drive mechanism or the actions of users. For some situations, e.g. in luxury hotels, resorts and the like, it is desirable that escalator handrails present a good appearance. Refinishing the surface of a handrail is not practical. It is therefore desirable to provide some way of applying some sort of a film to an escalator handrail, which can present a new appearance or finish to the handrail.

Accordingly, it is desirable to provide a film which can be readily applied in situ to an escalator handrail. Such a film should be capable of providing one or both of: a new, refinished appearance to the handrail; and advertising messages or logos.

Preferably, the film should be capable of application readily and simply, with minimum interruption in normal operation of the escalator. This should be achievable without requiring removal or replacement of the handrails.

Additionally, the inventors have realized that this covering should be sufficiently continuous, so as to minimize edges, etc which can promote accidental removal or entanglement in the drive mechanism. Further, this should be such as to minimize the opportunities for users to remove the surface finish or covering.

The invention is based on the concept of providing a film to the surface of the handrail, which film is both continuous and is removable.

In earlier U.S. application Ser. No. 09/252,784 and U.S. Pat. No. 6,450,228 issued from a Continuation-in-Part of that application, a flexible film with an adhesive layer was applied to a handrail, without any prestretching or tension. When a handrail, e.g. at the ends of an escalator or moving walkway, goes around a pulley, the handrail flexes, and in known manner the top portion of the handrail is stretched while the bottom portion is compressed. Indeed, the presence of steel cables or stretch inhibitors serve to define a neutral axis which is located in the top portion of the handrail. Consequently, part of the top of the handrail, above the steel cables is stretched or put in tension and the lower part of the top of the handrail and the lips are compressed. As the lips extend substantially below the neutral axis, they are subject to significant compression, as the handrail passes around end pulleys etc.

When a film is applied to the handrail, this means that edges of the film, located on the lips, are similarly compressed. In practice, this leads to wrinkling or puckering of the edges of the film. The adhesive used is unable to maintain adhesion of the extreme edges of the film to the handrail when it is subjected to the compression loading that results from flexing of the handrail.

In accordance with the present invention, there is provided a method of applying a flexible film to a moving handrail, with a desired degree of prestretch or elongation. Again, references to escalator handrails are to be understood to including handrails for moving sidewalks. The first step is to provide a flexible film comprising a first layer and a layer of adhesive on the underside thereof, wherein the film is generally elongate and having a width corresponding to the width of the handrail. The film is then aligned to the handrail and the first end of the film is adhered to the surface of the handrail. The handrail is then driven with respect to the film to cause the film to progressively and continuously adhere to the handrail. Simultaneously tension is applied to the film to pretension or prestretch the film. Finally, the full width is uniformly and smoothly adhered to the surface of the handrail.

The method may include providing the film on a roll and mounting the roll on a spindle adjacent to the handrail. A roller may then be applied to the surface of the handrail to press the film against the handrail. The method may further comprise progressively wrapping the film around the lips of the handrail by means of pairs of rollers mounted further apart around the outside of the handrail.

In accordance with a first aspect of the present invention, there is provided, in combination, an elongate handrail and a flexible film adhered to the handrail, the film comprising: a first film layer and a first layer of adhesive between the first film layer and the handrail, bonding the first film layer to the handrail, wherein the film has been applied to the handrail in tension, whereby the film includes a desired prestretch, thereby to at least reduce any tendency for edges of the film to separate from the handrail when these edges are subject to compressive strains.

In accordance with a second aspect of the present invention, there is provided a method of applying a flexible film to a moving handrail, the method comprising:

(1) providing a film comprising a first film layer and first layer of adhesive on the underside thereof, the film being generally elongate and having width corresponding to the width of the handrail;

(2) aligning and adhering a first end of the film to a surface of the handrail;

(3) applying a substantially constant tension load to the film to provide a desired degree of prestretch to the film;

(4) driving the handrail relative to the film, to cause the prestretched film to adhere continuously and progressively to the handrail; and

(5) ensuring that the full width of the film is uniformly and smoothly adhered to the surface of the handrail.

### BRIEF DESCRIPTION OF THE DRAWINGS

For a better understanding of the present invention and to show more clearly how it may be carried into effect, reference will now be made, by way of example, to the accompanying drawings which show the preferred embodiment of the present invention and in which:

FIG. 1 is a perspective view showing the apparatus in use on a balustrade of an escalator;

FIG. 2 is a perspective view showing the detail of motion of the film and a release sheet showing application of film to an escalator handrail;

FIGS. 3a, 3b and 3c are schematic views showing paths of the film and release sheet and wrapping of the film around the handrail;

FIG. 4a-4f are further cross-sectional views through a pressing mechanism, showing mounting of pressing rollers.

### DESCRIPTION OF THE INVENTION

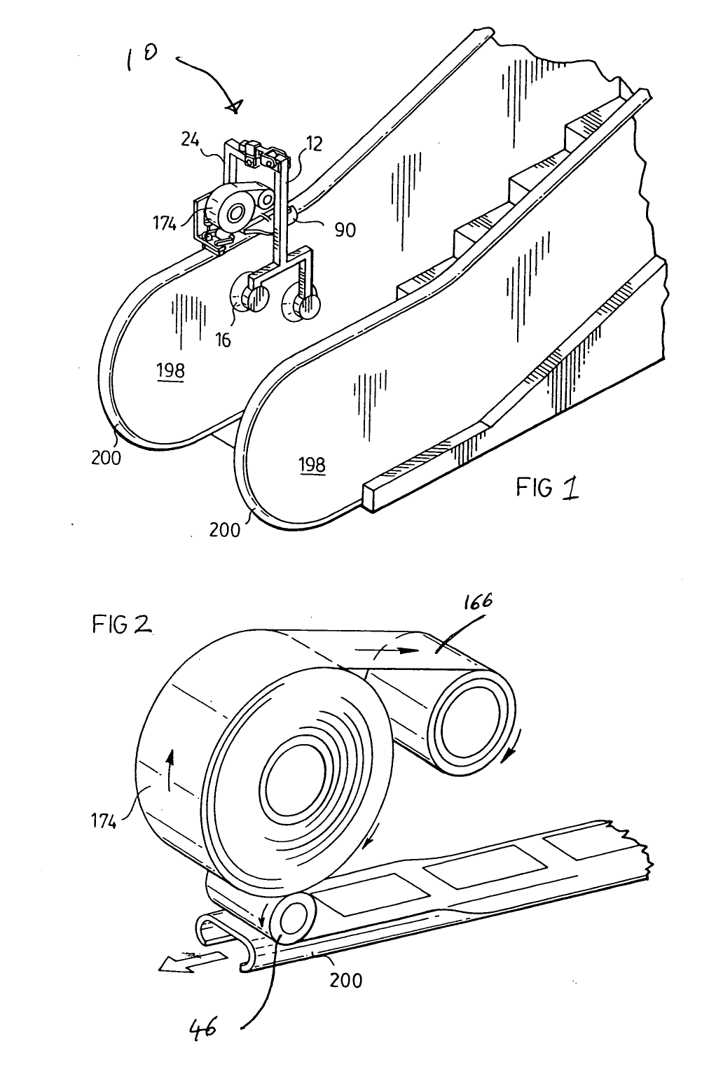

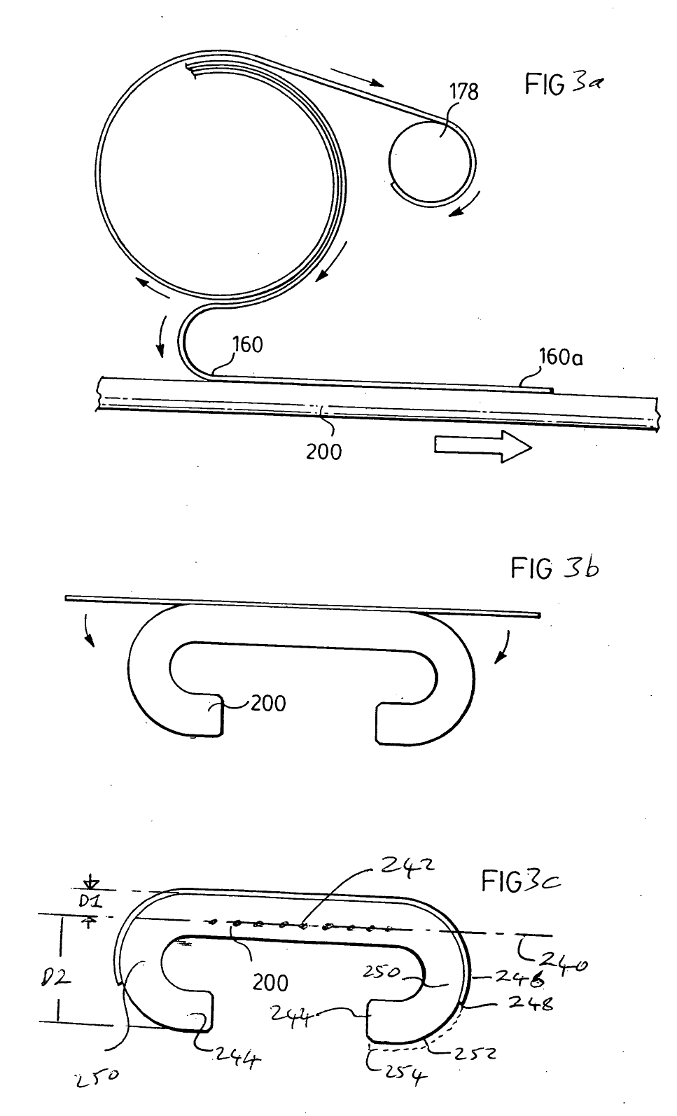

FIGS. 1 and 2 show the basic configuration and mode of use of an apparatus for applying a film to a handrail, as described in detail in U.S. Pat. No. 6,450,228, issued Sep. 17, 2002, the contents of which are hereby incorporated by reference.

In FIGS. 1 and 2, an apparatus 10 has a main support member 12, provided with suction cups 16 for mounting the apparatus as a whole to a balustrade of an escalator or moving handrail indicated at 198. The actual handrail is indicated at 200. The apparatus 10 also includes a downwardly extending member, on which there are mounted a spindle for a roll 174 of film to be applied to the handrail 220 and a spindle for a roll to take up a release sheet separated from the film as it is applied to the handrail 200 (the spindles not being shown). A drive mechanism is provided between the two spindles, with some sort of slip clutch assembly to ensure that the take up roll take up all the release sheet and maintains it in tension, indicated schematically in FIG. 2.

In addition to the spindles, a mechanism is provided, in accordance with the present invention, to apply a tension load to film unwound from the roll 174 on the first spindle. It is possible to provide some sort of clutch within the first spindle, similar to the clutch in the second spindle for taking up the release sheet (described below). This would have the effect of providing a somewhat constant torque to the second spindle. Consequently, as the roll of film is unwound, this would not provide an exact uniform tension to the film. Rather, it is preferable to provide some mechanism to ensure that a constant and desired tension load is applied to the film.

Reference will now be made to the Figures to describe a preferred film configuration and method of using the apparatus of the present invention.

The film used in the present invention can be as described in the above-mentioned U.S. Pat. No. 6,450,228, and as claimed in related applications. The film is indicated at 160 and comprises a first layer with a first adhesive layer on the underside thereof. The film 160 can be formed of polyurethane with a thickness in the range of approximately 0.5 to 3.0 mil, provided with a layer of adhesive with a thickness in the range of approximately 0.25 to 1 mil. To protect the film until this is applied and to enable the film to be wound up onto a sleeve, a release sheet 166 is provided in known manner.

On top of or below the first layer 162, printed matter is provided. This printed matter can be text, logos, images, etc., and it is expected that it will often comprise a repeated pattern. This printed matter would have a negligible thickness, so as not to significantly affect the thicknesses of other layers. This printed matter is printed directly onto the top or bottom of the first layer 162.

Following application of printed matter, a second layer with a respective second layer of adhesive can be applied to the top of the first sheet, so as to sandwich matter printed on the top of the first layer between the two layers. This serves to give added protection to the printed matter.

Each layer is preferably a polyurethane film having a thickness of 3 mils. The film is preferably a high-gloss, clear flexible film, coated with a clear acrylic pressure-sensitive adhesive. These films are provided with a release liner. Thus, if the printing is applied to the top of the first layer, the second layer with this associated adhesive as the release liner or sheet removed and is then applied to the top of the first layer to form the combined film shown.

A description will now be given of the use of the equipment of the present invention. Firstly, before a film is applied to a handrail, the handrail must be properly prepared. Most handrails, after a period of use, will acquire a film of dirt and grease, preventing proper adherence of an adhesive film.

Accordingly, the handrail is first washed with a suitable solvent, to remove all dirt and grease.

The handrail is then inspected for gouges or defects that impede application. If deep gouges are present, the handrail may need to be replaced before the film is applied.

Once clean, some handrails require to be coated with a sealant, to ensure that the applied film can be peeled off when required.

For an escalator, an operator is provided with two matched rolls of film, one for each handrail; the handrail is indicated at 200 and its balustrade at 198 in the drawings, while the rolls of film are indicated at 174.

The apparatus 10 is mounted to the balustrade 198, shown in FIGS. 1 and 2 preferably mounted at the top of the escalator for down escalator units and at the bottom of the escalator for up escalator units. On installations where obstacles prevent mounting at these locations, it is permissible to attach the apparatus 10 away from the ends on a straight, sloped portion of the handrail.

Once it has been established that the apparatus is properly centered with adequate clearances and that the film 160 is being applied uniformly without wrinkles, bubbles, etc., then the escalator can be operated to run the film around the entire length of the handrail.

As shown in FIG. 7b, the film 160 is initially planar and flat when it contacts the handrail 200, under the influence of a roller 46. The tension mechanism described above is such as to provide a desired tension or prestretch to the film. Typically, this will be of the order of 6 percent, and more generally is expected to be in the range of 5-8 percent, measured as a percent strain in the film.

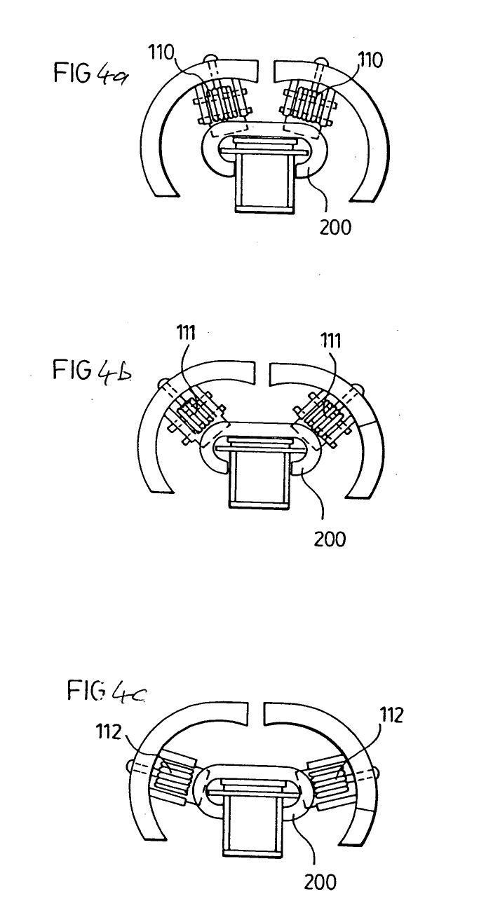

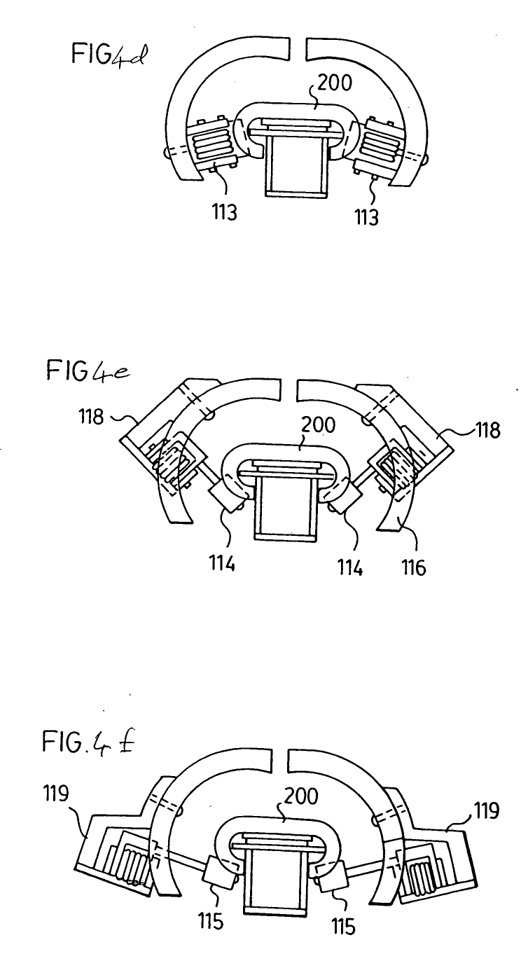

As the film 160 is drawn further along the handrail 200, the rollers 110-115 (FIG. 4) cause the film to progressively wrap around the handrail until the film is completely in contact with the handrail 200, as shown in FIG. 3c.

Now, as mentioned above, the difficulty with providing a flexible film for a handrail is that the handrail 200 is flexed in use. FIG. 3c indicates at 240 the neutral axis of the handrail, defined by tension elements indicated schematically at 242, these usually being a series of coplanar steel cables. As further indicated in FIG. 3c, this results in the top surface of the handrail 200 being spaced a distance D1 above the neutral axis 240, while the bottom of the lips, indicated at 244, are located a distance D2 below the neutral axis 240. In other words, as these steel cables have a much higher modulus of elasticity than the rest of the body of the handrail, typically made of resilient elastomeric material, it is almost solely the characteristics of the stretch inhibiting steel cables 242, which define the location of the neutral axis. The depth D2 is much greater than the depth D1.

As indicated at 246, in applicant's earlier application, it was proposed to wrap the film 160 only partially around the lips to the location approximately indicated at 246, i.e. slightly below the widest point of the handrail indicated by a line 248, representing the middle of shoulders 250 of the handrail. Even so, at such a location, the edges 246 of the film 160 are substantially below the neutral axis 240. Consequently, when the handrail 200 passes around rollers, for example, at the ends of the escalator, the handrail body below the neutral axis 240 is compressed, while the handrail body above the neutral axis 240 is stretched. For the film 160, stretching causes no difficulty. Firstly, the degree of stretching is relatively small, since it is noted the top surface is only a relatively small distance D1 from the neutral access. Secondly, the film is capable of withstanding the necessary degree of stretching and such stretching does not tend to lift the film from the handrail.

A difficulty occurs for the edge portions of the film, extending down to the edges 246. The edges 246 themselves are well below the neutral axis 240, and as such must compress to a significant extent, if they are to remain adhered to the handrail 200. In practice, it has been found that the edges 246, after repeated use, tend to show a wrinkling or puckering effect, i.e. the edges 246 tend to show short portions that remain adhered to the handrail 200 alternating with short portions that have wrinkled away from the handrail 200, to accommodate the compression of the handrail below the neutral axis 240.

Accordingly, the present invention provides a prestretching of film 160, so that the degree of prestretch, measured as a strain or percentage elongation of the film 160, is at least greater than the maximum degree of compressive reduction in length of the film, i.e. negative elongation, that could occur in use. This will than ensure that, all portions of the film 160, even when the handrail 200 is flexed will always be maintained in tension. The handrail body itself 200, particularly towards the lips 244 may be subjected to significant compressive strains, but the net strain in the film 160 will always be a tensile strain. Consequently, there should be no tendency for the film 160 to lift from the handrail body 200.

While such prestretching of the film will increase the total tensile load applied to the top portion of the film on top of the handrail 200, as this is only the relatively short distance D1 from the neutral axis, the total tensile strain applied to the film 160 should still be acceptable. For certain handrail designs, configurations and/all selection of materials for film 160, this may result in excessive tensile loads being applied to the film 160. In such cases, it may be possible to reduce the prestretch applied to the film 160, so that, for the edges of the film 160, small, compressive strains may be applied. These should be selected to be so small that they can be readily borne by the adhesive used to adhere the film 160 to handrail 200 without causing any significant wrinkling or puckering to occur.

In the earlier invention, as indicated at 246, the edges of the film 160 were located relatively high up the body of the handrail 200, with the intention of not imposing excessive compressive strains on the film 160. For the present invention, as these compressive strains are either totally eliminated or at least reduced to acceptable levels, it is now envisaged that the film 160 could extend around to locations such as those indicated at 252 or 254. Edges 252 are located further around the lips 244, while edges 254 anticipate the film 160 extending almost to the end of the lips 182. This is desirable, since edges that are located well under the main body of the handrail will not be visible or apparent to users. Edges that are in any way either visible, or detectable by feel when the user grips the handrail with a hand, encourage those users that have a tendency to pick at these edges. In time and with repeated usage, the edges then become damaged, resulting in the possibility of the film 160 becoming detached to a greater or lesser extent, and a possibility of the film or part of the film being caught up in the handrail drive mechanism.

In particular, the degree to which the film 160 wraps around the handrail can be adjusted and will depend on individual handrail profiles and installations. Having the film wrap a large way around the handrail lips is advantageous as it puts the edge of the film well away from users and not readily accessible to anyone who, for whatever reason, might want to try and peel it off. On the other hand, where the film wraps all the way around the lips, it can tend to buckle as the handrail travels around end rollers and the like. Accordingly, it is expected that some compromise will usually be needed between these two parameters.

1. In combination, an elongate handrail and a flexible film adhered to the handrail, the film comprising: a first film layer and a first layer of adhesive between the first film layer and the handrail, bonding the first film layer to the handrail, wherein the film has been applied to the handrail in tension, whereby the film includes a desired prestretch, thereby to at least reduce any tendency for edges of the film to separate from the handrail when these edges are subject to compressive strains.

2. A combination of a handrail and a film as claimed in claim 1, wherein the film extends, at least partially, around the outer surfaces of the shoulders of the handrail.

3. A combination of a handrail and a film as claimed in claim 1 or 2, which includes printed matter on the first film layer.

4 A combination of a handrail and a film as claimed in claim 3, wherein the film includes a second film layer and a second layer of adhesive bonding the second film layer on top of the first film layer.

5. A combination of a handrail and a film as claimed in claim 4, which includes printed matter, between the first film layer and the second film layer.

6. A combination of a handrail and a film as claimed in claim 3, wherein the printed matter comprises a pattern repeated at regular intervals along the length of the film.

7. A combination as claimed in claim 4, wherein each film layer comprises polyurethane with an approximate thickness in the range of 0.5 to 3 mil and an appropriate adhesive with an approximate thickness in the range of 0.25 to 1 mil.

8. A combination as claimed in claim 2, wherein the film extends around the shoulders of the handrail to the end of the lips of the handrail.

9. A combination of a handrail and a film as claimed in claim 1, wherein the handrail comprises a continuous loop of handrail, intended to be driven in use on an escalator or moving walkway, and wherein the film is generally continuous along the length of the handrail and includes end portions which overlap one another to form a joint.

10. A combination of a handrail and a film as claimed in claim 9, wherein the film extends around the outside of the handrail and at least partially covers the shoulders of the handrail.

11. A combination as claimed in claim 9 or 10, wherein the adhesive permits removal of the film, whereby, in use, the elongate handrail can be used with and without the flexible film and the flexible film can be exchanged for another flexible film.

12. A combination as claimed in claim 1, wherein the amount of prestretch applied to the film is in the range of 5 to 8 percent measured as a strain applied to the film.

13. A combination as claimed in claim 12, wherein the amount of prestretch is substantially 6 per cent measured as a strain applied to the film.

14. A method of applying a flexible film to a moving handrail, the method comprising:
(1) providing a film comprising a first film layer and first layer of adhesive on the underside thereof, the film being generally elongate and having width corresponding to the width of the handrail;
(2) aligning and adhering a first end of the film to a surface of the handrail;
(3) applying a substantially constant tension load to the film to provide a desired degree of prestretch to the film;
(4) driving the handrail relative to the film, to cause the prestretched film to adhere continuously and progressively to the handrail; and
(5) ensuring that the full width of the film is uniformly and smoothly adhered to the surface of the handrail.

15. A method as claimed in claim 13, which includes providing the film on a first roll and mounting the first roll on a first spindle adjacent the handrail, and in step (4) applying a roller to the surface of the handrail to press the film against the handrail.

16. A method as claimed in claim 13, which includes providing a film having a width sufficient to wrap around the shoulders of the handrail, the method including progressively wrapping the film around the shoulders of the handrail by means of a plurality of pairs of rollers, each pair of rollers being mounted successively further apart and around the outside of the handrail.

17. A method as claimed in claim 13, which includes providing the film with sufficient width to reach the ends of the lips of the handrail and, in step (5) wrapping the film around the shoulders of the handrail to the ends of the lips of the handrail.

18. A method as claimed in claim 14, wherein step (3) comprises applying a prestretch to the film in the range of 5 to 8 percent measured as a strain applied to the film.

19. A combination as claimed in claim 15, wherein step (3) comprises applying a prestretch of substantially 6 per cent measured as a strain applied to the film.
